(19) United States
(12) Patent Application Publication
(10) Pub. No.: US 2012/0130837 A1
(43) Pub. Date: May 24, 2012

(54) SYSTEM AND METHOD FOR REMOTELY CONTROLLING ACCESS TO MEDIA ON A PUBLISHER SITE

(76) Inventors: Jeffrey TINSLEY, Los Angeles, CA (US); Matthew Mitchell, Calabasas, CA (US)

(21) Appl. No.: 13/301,742

(22) Filed: Nov. 21, 2011

Related U.S. Application Data
(60) Provisional application No. 61/415,809, filed on Nov. 19, 2010.

(51) Int. Cl. G06Q 30/06

(52) U.S. Cl. 705/26.1

(57) ABSTRACT

A service, system or component is provided that controls publication of media content on a publisher site to a visitor of the publisher site. Media content on the publisher site can be blocked for to such visitors for purpose of revenue collection.

### RELATED APPLICATIONS

This application claims benefit of priority to Provisional U.S. Patent Application No. 61/415,809, filed Nov. 19, 2010; the aforementioned priority application being hereby incorporated by reference in its entirety.

### TECHNICAL FIELD

Embodiments described herein pertain generally to online content publication, and more specifically, to a system and method for remotely controlling access to media on a publisher site.

### BRIEF DESCRIPTION OF THE DRAWINGS

FIG. 1 is an overview of a system for remotely controlling access to media on a publisher site, according to an embodiment.

FIG. 2 illustrates components that comprise a service such as described with FIG. 1, according to one or more embodiments.

FIG. 3 illustrates a method for enabling a service to remotely control public access to content provided by a publisher site, according to an embodiment.

FIG. 4 is a block diagram that illustrates a computer system upon which embodiments described herein may be implemented.

### DETAILED DESCRIPTION

Embodiments described herein pertain generally to online content publication, and more specifically, to a system and method for controlling online content publishing.

According to at least some embodiments, a service, system or component is provided that controls publication of media content on a publisher site to a visitor of the publisher site. Media content on the publisher site can be blocked for to such visitors for purpose of revenue collection.

In particular, some embodiments provide a service that enables publishers to collect revenue on media content made available at their website. A service provides functionality to a publisher site that results in visitors of the site having to provide payment to the service. Once visitors provide payment to the service, the service remotely unlocks the content. The service may operate as an intermediary, in that it is remote and independent of the publisher site.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

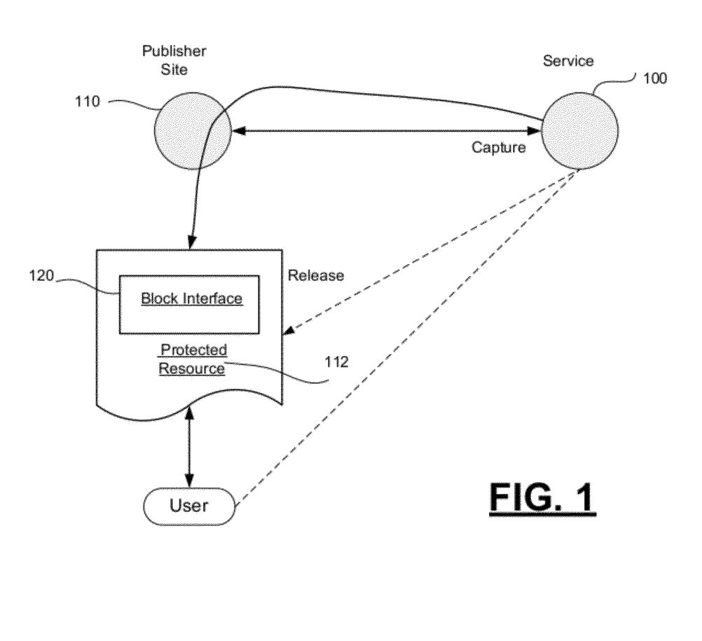

FIG. 1 is an overview of a system for remotely controlling access to media on a publisher site, according to an embodiment. In particular, embodiments provide a service that enables publishers to charge fees or place other conditions for accessing resources on their websites. According to some embodiments, a service 100 provides a blocking interface that blocks access to media resources provided on a given publisher's site, pending payment of fees by site visitors. The service 100 may operate at its own site, accessible to publishers and visitors over, for example, the World Wide Web. A publisher (as represented by publisher site 110) can subscribe to service 100 to facilitate the publisher's ability to charge visitors of its site for access to the publisher's media resources. Specific examples of publisher media resources can include video clips, audio clips, pictures, documents or multi-media presentations. As a specific example, the publisher site 110 may be a blog that publishes original video clips about a particular subject. Under conventional approaches, the publisher 110 would have to integrate functionality into its website in order to ensure its pay-for-content features are available to only those visitors who have made payments. In contrast to such approaches, embodiments described herein simplify for publishers the process by which publishers can protect and make media (e.g. video) available to visitors in exchange for payment.

According to embodiments described herein, the service 100 enables the publisher to utilize functionality provided by service 100 in order to limit public access to the publisher's media resources to visitors that provide payment. Under one embodiment, the publisher subscribes to the service 100, and a legal arrangement is formed between the publisher and the service 100. The legal arrangement can specify a revenue sharing plan between service 100 and the publisher. Once the publisher is engaged with the service 100, the publisher can specify, for example, the URL corresponding to the location of the media resource that is to be protected and made for-pay. Additionally, the publisher can also specify payment terms, such as how much a visitor is to pay for access to the media (or to the publisher's site), or the duration of access for pay.

The service 100 includes functionality for triggering a blocking interface 120 each time content or resource 112 from the publisher site 110 is downloaded onto a terminal. In some embodiments, the service 100 includes functionality for (i) enabling the site visitor to interact with the blocking interface 120 in order to provide payment information that is then handled by the service 100, and (ii) determining whether a particular site visitor is entitled to access the media by having previously paid for access. In the latter case, the blocking interface 120 is suppressed or not activated.

Once the blocking interface 120 is operational on the publisher site, site visitors are unable to access the protected media resource (e.g. a particular media object or file). In some implementations, the site visitor can view, for example, an image or grey screen for the protected media, without actual ability to trigger playback of the protected media 112. The blocking interface 120 can also include information and links to service 100 for enabling the site visitor to enter payment information (e.g. credit card number). Once this information is entered, the service 100 releases the protected content. For example, the blocking interface 120 may be de-activated or suppressed.

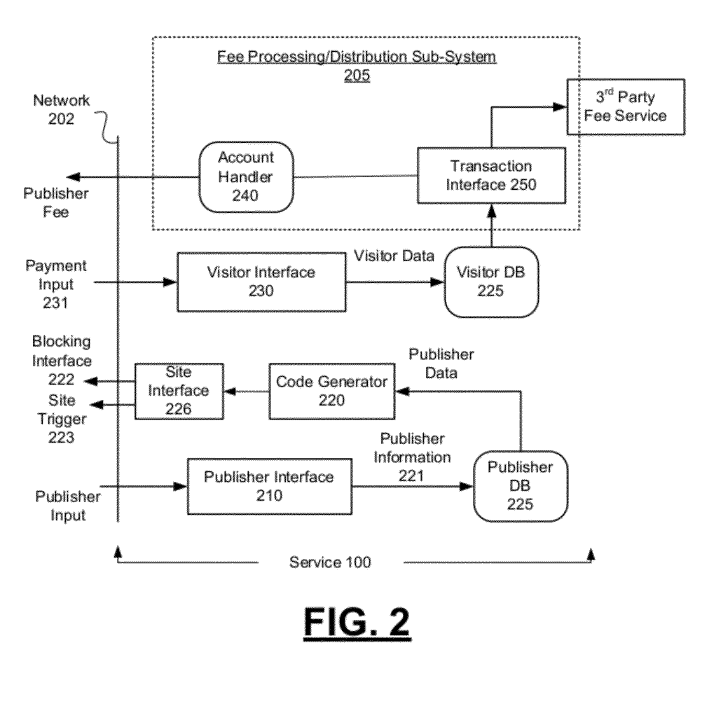

FIG. 2 illustrates components that comprise a service such as described with FIG. 1, according to one or more embodiments. As shown, service 100 includes a publisher interface 210, one or more code generators 220, a site interface 226, and a visitor interface 230. The service 100 also includes a fee processing and distribution system 205.

The publisher interface 210 is accessible to publishers over network 202. In one embodiment, a publisher can access the service 100 using a browser, then enter information 221 that specifies the location of the content the publisher wants to protect and make “pay-for-access”. The publisher may specify the location of the content by copying and pasting a URL to the interface 210 of the service 100. As an addition or alternative, the publisher can also specify information such as payment terms (e.g. how much the visitor to the publisher website is to pay for protected content, whether the access is single instance or for a duration etc.). According to some embodiments, the publisher information 221 may also include customization information. For example, the publisher may elect to customize information presented to visitors as part of the blocking interface 222.

A publisher database 225 can be used to maintain information about each publisher. The publisher database 225 may store information about individual publishers, including the customization data or other input provided by the publisher.

In one implementation, the code generator 220 generates a trigger script 223 that the publisher can copy and paste onto the protected web page. Once the page is loaded, the trigger script causes the visitor's browser (or other component) to access resources of service 100 for other functionality. For example, a sequence of function calls may be executed, initiating with the trigger script 223 being run on the visitor's terminal. A publisher site interface 226 may handle and respond to such function calls. The resulting functionality that may be executed as the page is loaded may provide for a blocking interface to be presented to the visitor. The blocking interface 222 blocks access to, for example, a video file on the publisher site. At the same time, the visitor has loaded the page and is able to read information presented in the blocking interface 222 (e.g. the payment terms), as well as activate links provided with the blocking interface. As mentioned, the blocking interface 222 may also carry content based on customization data provided from a particular publisher. Thus, for example, the blocking interface 222 may use publisher-specific data retrieved from the publisher database 225 in presenting a message or other content in the interface.

In addition to providing the blocking interface, functionality that may be provided by the combination of the code generator 220 and the publisher site interface 226 include a programmatic determination as to whether the visitor is entitled to access the protected content. In one embodiment, such functionality makes a determination as to whether the user has previously paid for the right to access the protected content. The visitor can be identified by, for example, cookie placement, so that subsequent instances of the user visiting the website can be detected. Depending on payment terms, the user's past payment may provide the user with access to the protected content.

If the blocking interface 222 is provided to the visitor, the visitor can elect to release the blocking interface 222 by interfacing with service 100 and providing payment input 231 (e.g. credit card number). In one embodiment, the blocking interface 222 includes a link that navigates the user's browser or terminal to the visitor interface 230 of the service 100. At the visitor interface 230, the user can select payment terms and conditions, and provide payment (e.g. credit card number). A visitor database 225 may retain information about individual visitors for future use. In particular, the service 100 may associate individuals with programmatic identifiers or classifications, such as provided by way of cookies. Such information may be stored in the visitor database 225.

According to some embodiments, the fee processing and distribution sub-system 205 collects fees from visitors and distributes funds to publishers. In an embodiment, the sub-system 205 includes an account handler 240 and a transaction interface 250. A visitor may specify credit card information, which can be stored in the visitor database 225 for future use. The transaction interface 250 may communicate the information and receive payment authorization from a credit authorization service (E.g. VISA). The account handler 240 may distribute portions of the funds received to the publisher site.

In some embodiments, the service 100 operates under rules or conditions that enable it to transact with credit card companies for content it does not actually provide. In order to comply, the service 100 may operate as a content reseller, and perform actions consistent with being a reseller. In one implementation, the service 100 captures screen shots of the protected content as part of qualifying as a reseller.

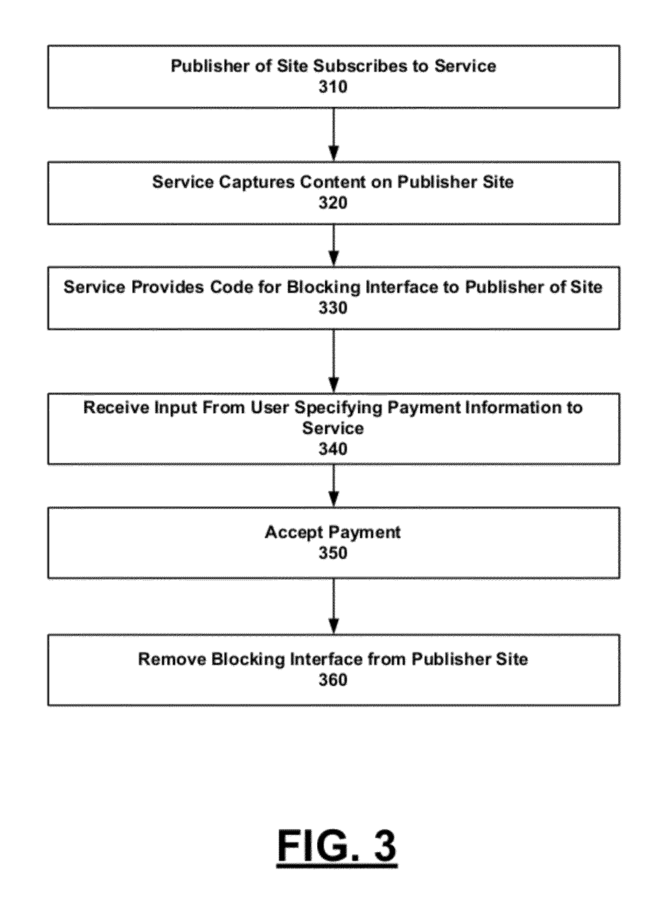

FIG. 3 illustrates a method for enabling a service to remotely control public access to content provided by a publisher site, according to an embodiment. And method such as described by an embodiment of FIG. 3 may be implemented using components such as described in FIG. 1. Accordingly, reference to numerals of FIG. 1 is made to illustrate suitable components for performing a step or sub-step being described.

A publisher of this site may subscribe to a service that enables public control access functionality, such as described. (310) The publisher may correspond to, for example, a blog or website on which content is provided. Examples of content that a publisher may protect (e.g. enable access on payment terms) include video clips and multimedia content. The publisher can utilize the publisher interface 120 of service 100 in order to provide information such as (i) a network location of the publisher website (e.g. URL); (ii) file or page location to the particular media content that the publisher wishes to protect, if different from the publisher website; and/or (iii) access terms to visitors, such as the number of times a particular visitor can access a particular page or media content upon providing payment. In the latter case, the service 100 may provide different payment plans, such as a subscription plan by which visitors can pay for access over a given duration of time (e.g. week or month), or a payment plan in which the visitors pay for a set number of instances in which they can access the protected media content from the publisher.

Numerous other types of information may be provided from the publisher. For example, the publisher can enter customization content, such as a logo or text content that is to overlay the location of the media content on the webpage when the media content is in the inaccessible state. The publisher may also specify configuration content, such as whether to publisher has a preference for (i) displaying a video still from the content that is being protected on the publisher site, (ii) a gray out with a diminished image that is from, or pertinent to, the content that is being controlled, (iii) information regarding the payment terms and/or mechanism(s) by which the visitor can make payment, or perform other tasks, for unlocking access to the media content. In the latter case, a URL or other network identifier to the service may be provided, as a mechanism by which the visitor can provide credit card payment information.

According to some embodiments, the service 100 captures content from the publisher site as part of the service's functionality for enabling visitors to pay the service 100 using credit cards (or other similar transactional service), in order to access content on the publisher site. (320) In particular, embodiments enable visitors of publisher sites to make credit card payment directly to the service 100. The service 100 then distributes portions of the funds charged to publishers. In order to accept payment as a separate and independent service from the publisher, the service 100 may perform specific functions to comply with rules of credit card authorization services (e.g. VISA or MASTERCHARGE). Among compliance requirements, the service 100 may need to act as a reseller of content provided by publishers. As one form for such compliance, the service 100 may capture content from the publisher site that subscribes to the service. The captured content may provide technical compliance to financial institution rules that require parties who accept credit card payments to be resellers. The service 100 can release the content it captures to visitors as part of its exchange with paying visitors. More specifically, visitors provide payment (e.g. by way of specifying credit card information) in order for service 100 to remove the blocking of the protected content on the publisher site. As part of the exchange, service 100 releases the captured content to the visitor upon receiving payment. Legal agreements may be exchanged with both publisher and individual visitors to specify the resell arrangement by which content is released to the visitor from the publisher site.

Once the publisher enters its information, the functionality of the blocking interface 222 is provided for the publisher site. (330) In one embodiment, the service 100 provides the publisher with a script that is triggered when the page is downloaded by a visitor. In one implementation, once the page is downloaded, a script may call programmatic resources of the service 100 in order enable the blocking functionality to be implemented on the page.

In one embodiment, the functionality of the blocking interface 222 includes the following: (i) identify the visitor by person or by terminal (e.g. use cookie identification); (ii) if the person is previously authorized (e.g. they have already provided payment), then do not block the protected media content on the publisher site; (iii) if the person has not been authorized, then block the protected content. The blocking interface 222 can include a still replacement image or overlay on the portion of the page where the protected media resides. The blocking interface 222 may also include functionality for disabling the ability for the user to play or render the protected media. As mentioned with other embodiments, the still replacement image or overlay may carry content that informs the user on how he can pay for access to the protected content from the service 100.

Once the blocking functionality is distributed to the publisher site, visitors may elect to access service by, for example, using a link provided in the replacement image or overlay. The service 100 provides the visitor interface to these visitors to enable the visitors to provide information for making credit card or other electronic payments. (340)

Once information is received from the visitors, the transaction interface 250 interacts with a transaction service (e.g. VISA or MASTERCARD). (350) The account handler 240 can then accumulate funds, and periodically distribute an agreed upon portion of the funds to the publishers.

For individual visitors, once the payment information is received, the blocking interface 222 is removed or disabled for that particular visitor. (360) The service 100 may control the blocking functionality 222 remotely and disable it upon payment information being received or authorized. With the blocking functionality 222 removed or disabled, the visitor of the publisher site is able to render and/or playback the protected media resource.

Computer System

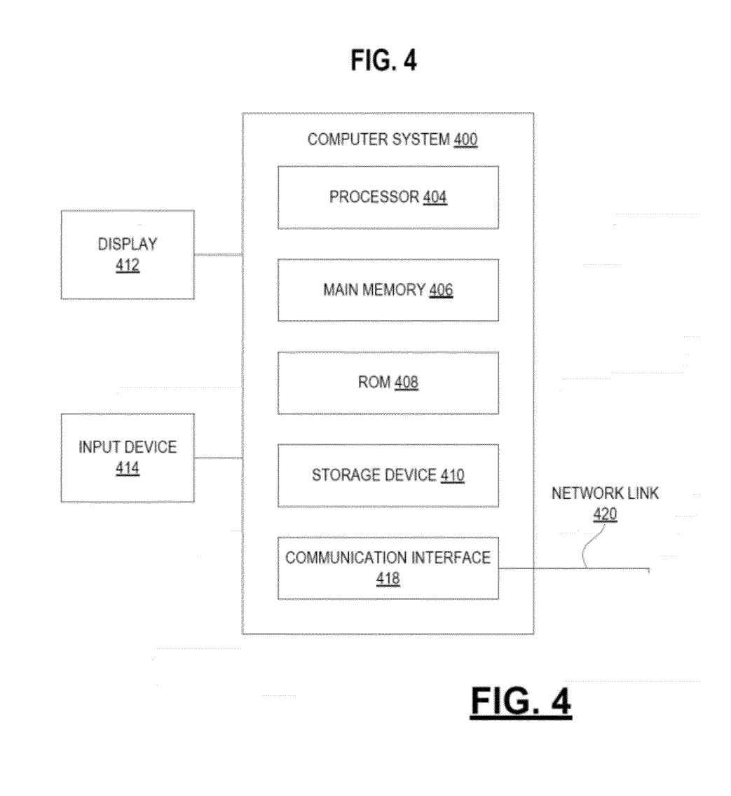

FIG. 4 is a block diagram that illustrates a computer system upon which embodiments described herein may be implemented. For example, in the context of FIG. 1, system 100 may be implemented using a computer system such as described by FIG. 4.

In an embodiment, computer system 400 includes processor 404, main memory 406, ROM 408, storage device 410, and communication interface 418. Computer system 400 includes at least one processor 404 for processing information. Computer system 400 also includes a main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 may also include a read only memory (ROM) 408 or other static storage device for storing static information and instructions for processor 404. A storage device 410, such as a magnetic disk or optical disk, is provided for storing information and instructions. The communication interface 418 may enable the computer system 400 to communicate with one or more networks through use of the network link 420.

Computer system 400 can include display 412, such as a cathode ray tube (CRT), a LCD monitor, and a television set, for displaying information to a user. An input device 414, including alphanumeric and other keys, is coupled to computer system 400 for communicating information and command selections to processor 404. Other non-limiting, illustrative examples of input device 414 include a mouse, a trackball, or cursor direction keys for communicating direction information and command selections to processor 404 and for controlling cursor movement on display 412. While only one input device 414 is depicted in FIG. 4, embodiments may include any number of input devices 414 coupled to computer system 400.

Embodiments described herein are related to the use of computer system 400 for implementing the techniques described herein. According to one embodiment, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawing him in s, variations to specific embodiments and details are encompassed by this disclosure. It is intended that the scope of the invention is defined by the following claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for controlling access to content on a website, the method comprising:
enabling a publisher to register a publisher site with a service operating remotely and independently from the publisher site;
generating, from the service, a code for the publisher site in response to the publisher registering the publisher site, the code including a trigger that executes upon a resource of the publisher site being loaded by a visitor to the publisher site;
in response to the trigger executing, generating, from the code, a blocking interface that (i) blocks the visitor from receiving media content embedded in the resource of the publisher site, while (ii) enabling the visitor to view at least a portion of the resource of the publisher site;
enabling the visitor to enter payment information for receiving the media content at a site operated by the service;
removing the blocking interface once the visitor enters the payment information, so that the visitor is able to view the media content embedded in the resource of the publisher site.

2. The method of claim 1, further comprising:
detecting a subsequent instance of the visitor loading either the resource or another resource of the publisher site;
making a determination that the user has previously provided the payment information; and
enabling the user to view the media content embedded in the resource of the publisher site without providing the blocking interface.

3. The method of claim 1, wherein enabling the publisher to register the publisher site includes purchasing a usage of the media content embedded in the resource from the visitor, and wherein enabling the visitor to enter payment information for receiving the media content includes reselling the visitor the usage of the media content purchased from the publisher.

4. The method of claim 3, wherein reselling the visitor the usage of the media content includes collecting funds from the visitor using the payment information.

5. The method of claim 3, further comprising distributing funds from the service to the publisher based in part on funds collected from the visitor when reselling the usage of the media content to the visitor.

6. The method of claim 4, wherein collecting funds from the visitor using the payment information includes collecting the funds from a credit card account of the visitor using a credit card specified by the visitor.

7. The method of claim 6, wherein collecting the funds from the credit card account of the visitor includes implementing rules and conditions of a provided of the credit card in reselling the media content.

8. The method of claim 1, wherein generating the blocking interface includes providing on the interface at least some content from or information about the media content.

9. The method of claim 1, wherein generating the blocking interface includes providing a customization on the interface that is specific to the publisher or publisher site.

10. The method of claim 1, wherein generating the blocking interface includes providing a customization on the interface that is specified by the publisher of publisher site.
